(19) United States
(12) Patent Application Publication
(10) Pub. No.: US 2014/0314273 A1
(43) Pub. Date: Oct. 23, 2014

(54) Method, Apparatus and Computer Program Product for Object Detection

(71) Applicant: Veldandi Muninder, Bangalore (IN)

(72) Inventor: Veldandi Muninder, Bangalore (IN)

(73) Assignee: Nokia Corporation, Espoo (FI)

(21) Appl. No.: 14/123,840

(22) PCT Filed: Apr. 5, 2012
(86) PCT No.: PCT/FI2012/050351

§ 371 Date: Feb. 17, 2014

(30) Foreign Application Priority Data
Jun. 7, 2011 (IN) 1941/CHE/2011

(51) Int. Cl. G06K 9/62

(52) U.S. Cl. CPC G06K 9/6262; G06K 9/6232
USPC 382/103

(57) ABSTRACT

In accordance with an example embodiment a method and apparatus is provided. The method comprises detecting presence of an object portion in at least one sub-window in an image based on a first classifier. The first classifier is associated with a first set of weak classifiers. A set of sample sub-windows is generated corresponding to the at least one sub-window by performing at least one of a row shifting and column shifting of the at least one sub-window. A presence of the object portion in the set of sample sub-windows is detected based on a second classifier. The second classifier is associated with a second set of weak classifiers. The presence of the object portion is determined in the at least one sub-window based on the comparison of a number of sample sub-windows in the set of sample sub-windows comprising the object portion with a predetermined threshold number.

### TECHNICAL FIELD

Various implementations relate generally to method, apparatus, and computer program product for object detection in media content.

### BACKGROUND

Object detection in media content, such as images is increasingly gaining use in applications such as media capture, video editing, video compression, human computer interaction and the like. The detection of objects, such as a face in an image involves training a model or a classifier with similar objects offline. For example, for detecting a face in the media content, a classifier may be trained with multiple samples of faces. In addition, the object classifiers or models are trained according to an orientation thereof. For instance, a frontal trained classifier may detect frontal pose faces, and so on. Various other examples of the classifiers may include those trained for detecting specific object orientations or poses.

### SUMMARY OF SOME EMBODIMENTS

Various aspects of examples embodiments are set out in the claims.

In a first aspect, there is provided a method comprising: detecting presence of an object portion in at least one sub-window in an image based on a first classifier, the first classifier being associated with a first set of weak classifiers; generating a set of sample sub-windows corresponding to the at least one sub-window detected by the first classifier by performing at least one of a row shifting and column shifting of the at least one sub-window; detecting a presence of the object portion in the set of sample sub-windows based on a second classifier, the second classifier being associated with a second set of weak classifiers; and determining the presence of the object portion in the at least one sub-window based on the comparison of a number of sample sub-windows detected by the second classifier in the set of sample sub-windows comprising the object portion with a predetermined threshold number.

In a second aspect, there is provided an apparatus comprising: at least one processor; and at least one memory comprising computer program code, the at least one memory and the computer program code configured to, with the at least one processor, cause the apparatus at least to perform: detecting presence of an object portion in at least one sub-window in an image based on a first classifier, the first classifier being associated with a first set of weak classifiers; generating a set of sample sub-windows corresponding to the at least one sub-window detected by the first classifier by performing at least one of a row shifting and column shifting of the at least one sub-window; detecting a presence of the object portion in the set of sample sub-windows based on a second classifier, the second classifier being associated with a second set of weak classifiers; and determining the presence of the object portion in the at least one sub-window detected by the second classifier based on the comparison of a number of sample sub-windows in the set of sample sub-windows comprising the object portion with a predetermined threshold number.

In a third aspect, there is provided a computer program product comprising at least one computer-readable storage medium, the computer-readable storage medium comprising a set of instructions, which, when executed by one or more processors, cause an apparatus to at least perform: detecting presence of an object portion in at least one sub-window in an image based on a first classifier, the first classifier being associated with a first set of weak classifiers; generating a set of sample sub-windows corresponding to the at least one sub-window detected by the first classifier by performing at least one of a row shifting and column shifting of the at least one sub-window; detecting a presence of the object portion in the set of sample sub-windows based on a second classifier, the second classifier being associated with a second set of weak classifiers; and determining the presence of the object portion in the at least one sub-window based on the comparison of a number of sample sub-windows detected by the second classifier in the set of sample sub-windows comprising the object portion with a predetermined threshold number.

In a fourth aspect, there is provided an apparatus comprising: means for detecting presence of an object portion in at least one sub-window in an image based on a first classifier, the first classifier being associated with a first set of weak classifiers; means for generating a set of sample sub-windows corresponding to the at least one sub-window detected by the first classifier by performing at least one of a row shifting and column shifting of the at least one sub-window; means for detecting a presence of the object portion in the set of sample sub-windows based on a second classifier, the second classifier being associated with a second set of weak classifiers; and means for determining the presence of the object portion in the at least one sub-window based on the comparison of a number of sample sub-windows detected by the second classifier in the set of sample sub-windows comprising the object portion with a predetermined threshold number.

In a fifth aspect, there is provided a computer program comprising program instructions which when executed by an apparatus, cause the apparatus to: detect presence of an object portion in at least one sub-window in an image based on a first classifier, the first classifier being associated with a first set of weak classifiers; generate a set of sample sub-windows corresponding to the at least one sub-window detected by the first classifier by performing at least one of a row shifting and column shifting of the at least one sub-window; detect a presence of the object portion in the set of sample sub-windows based on a second classifier, the second classifier being associated with a second set of weak classifiers; and determine the presence of the object portion in the at least one sub-window based on the comparison of a number of sample sub-windows detected by the second classifier in the set of sample sub-windows comprising the object portion with a predetermined threshold number.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for object detection in media content in accordance with an example embodiment;

FIG. 3 illustrates an exemplary custom shape window for object detection in the media content in accordance with an example embodiment;

FIG. 4 is a flowchart depicting an example method for training classifiers for object detection in media content in accordance with an example embodiment;

FIG. 5 illustrates a block diagram for object detection in accordance with an example embodiment; and

FIG. 6 is a flowchart depicting an example method for object detection in the media content in accordance with an example embodiment.

### DETAILED DESCRIPTION

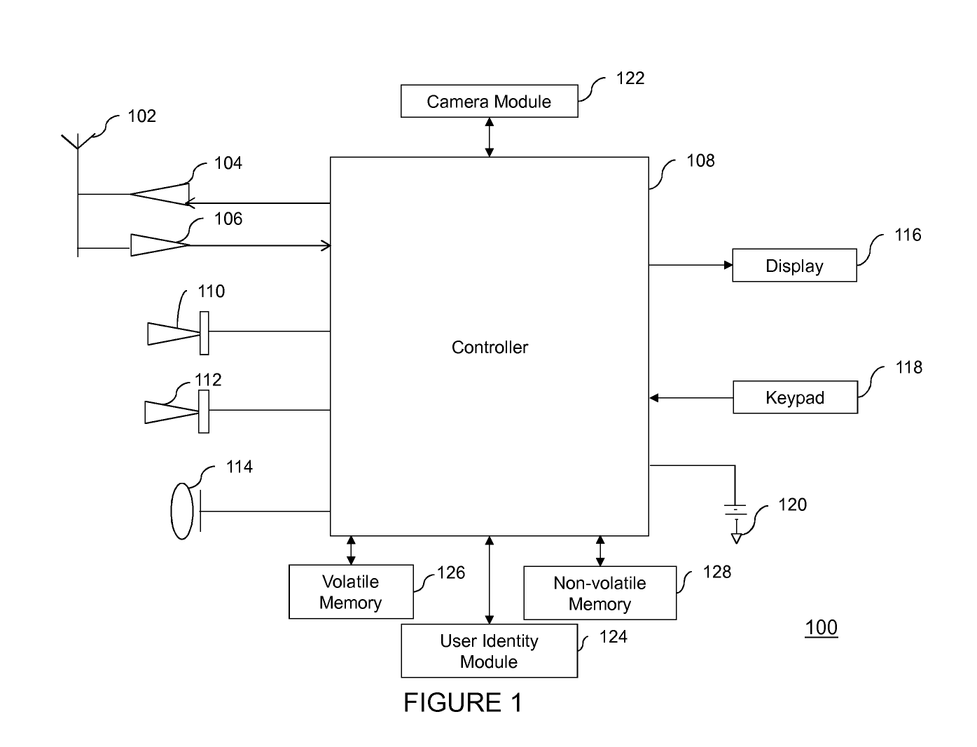

Example embodiments and their potential effects are understood by referring to FIGS. 1 through 6 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data.

The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

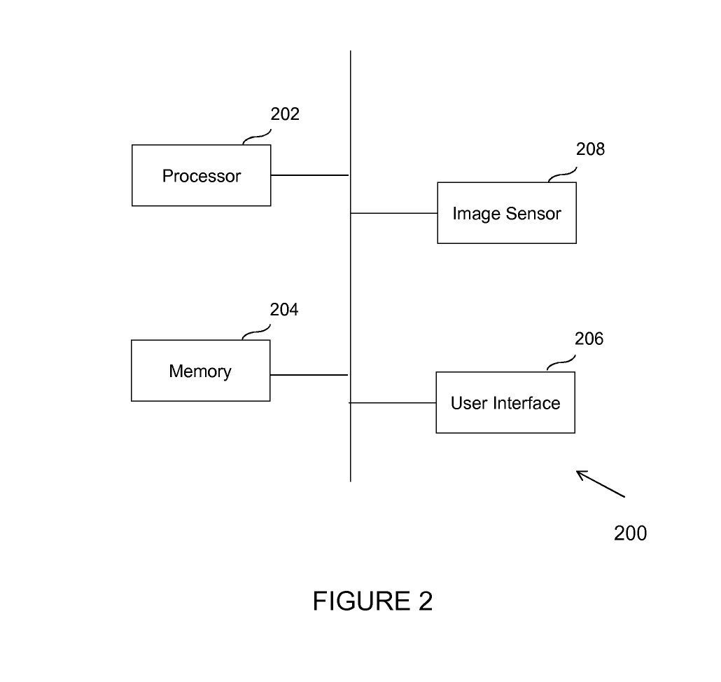

FIG. 2 illustrates an apparatus 200 for object detection in the media content in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus 200 is a mobile phone, which may be an example of a communication device. Alternatively or additionally, embodiments may be employed on a combination of devices including, for example, those listed above. Accordingly, various embodiments may be embodied wholly at a single device, for example, the device 100 or in a combination of devices. It should be noted that some devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the communication device may be embodied as to include an image sensor, such as an image sensor 208. The image sensor 208 may be in communication with the processor 202 and/or other components of the apparatus 200. The image sensor 208 may be in communication with other imaging circuitries and/or software, and is configured to capture digital images or to make a video or other graphic media files. The image sensor 208 and other circuitries, in combination, may be an example of the camera module 122 of the device 100.

In an example embodiment, the processor 202 is configured to, with the content of the memory 204, and optionally with other components described herein, to cause the apparatus 200 to detect an object in the media content. In an example embodiment, the object is a face of a subject. The media content may be any image, video, any other graphic content that can feature faces. The media content may be received from internal memory such as hard drive, random access memory (RAM) of the apparatus 200, or from the memory 204, or from external storage medium such as digital versatile disk (DVD), compact disk (CD), flash drive, memory card, or from external storage locations through the Internet, local area network, Bluetooth®, and the like. In an example embodiment, the media content such as the image or the video may be instantaneously captured by the image sensor 204 and other circuitries.

In an example embodiment, the processor 202 is configured to, with the content of the memory 204, and optionally with other components described herein, to cause the apparatus 200 to detect an object belonging to a wide range of orientations by utilizing a minimum set of classifiers, thereby reducing the complexity of computation involved in detecting the objects of varying orientations. In an example embodiment, the object may be a face. A face samples associated with a range of face orientations may be classified by utilizing the minimum set of classifiers. In an example embodiment, the detection of an object may be performed for orientations ranging between 0 to 90 Yaw. For example, orientations of 0 to 90 Yaw may represent object portion orientation ranging between a frontal face orientation portion to a profile face orientation. In addition, the detection of the object may be performed by a minimum number of classifiers that may be trained by utilizing a plurality of sample images. In an example embodiment, the training of the set of classifiers also includes performing training on a large range of poses ranging from, for example, 0 to 90 Yaw faces.

In an example embodiment, the processor 202 is configured to, with the content of the memory 204, and optionally with other components described herein, to cause the apparatus 200 to receive an image. In an example embodiment, the image may include a plurality of sub-windows.

In an example embodiment, the processor 202 is configured to, with the content of the memory 204, and optionally with other components described herein, to cause the apparatus 200 to detect presence of an object portion in at least one sub-window of the plurality of sub-windows in the image based on a first classifier. The first classifier may be associated with a first set of weak classifiers. Examples of the first set of weak classifiers associated with a face portion include, but are not limited to, a pair of eyes and a mouth portion. In an embodiment, the first set of weak classifiers may be derived based on the local binary pattern (LBP) values of pixels associated with sample images utilized for training of the first classifier. In an example embodiment, a processing means may be configured to detect the object portion in the at least one sub-window in the image based on the first classifier. An example of the processing means may include the processor 202, which may be an example of the controller 108.

In an example embodiment, the first classifier includes a first plurality of layers of classification functions. The first plurality of layers of the classification functions include layers such as n₁, n₂, . . . nₙ₁, and the like. Layers of the first plurality of layers of the classification function is representative of a decision function consisting of weak classifiers, and capable of deciding whether to reject a sample sub-window as a non-object (for example, non-face) or pass the sample sub-window to a subsequent layer for evaluation, In an embodiment, the classification functions are based on a set of weak classifiers, such as the first set of weak classifiers of the object portion, and corresponding thresholds. In an example embodiment, the threshold of the first classifier is relaxed, thereby allowing more number of face samples to be detected along with false alarms. In another embodiment, the threshold of the first classifier may be determined in a manner for allowing a very high detection accuracy and moderate false rejection rate.

In an example embodiment, the processor 202 is configured to, with the content of the memory 204, and optionally with other components described herein, to cause the apparatus 200 to generate a set of sample sub-windows corresponding to the at least one sub-window. In an example embodiment, the set of sample sub-windows may be generated when the presence of the object portion is determined in the at least one sub-window by the first classifier. In an example embodiment, the set of sample sub-windows may be generated by performing at least one of a row shifting and column shifting of the at least one sub-window. In an example embodiment, the at least one of the row shifting and column shifting of the at least one sub-window may be performed based on the following expression:

A_{x,y}(m,n)=A(m+x,n+y),

wherein A is the sub-window, and
A_{x,y} is the generated sample sub-window.

For example, when x varies from a value of −2 to +2, and y varies from a value of −2 to +2, 25 sample sub-windows may be generated. In an example embodiment, a processing means may be configured to generate the set of sample sub-windows corresponding to the at least one sub-window when the at least one sub-window is detected to include the object portion. An example of the processing means may include the processor 202, which may be an example of the controller 108.

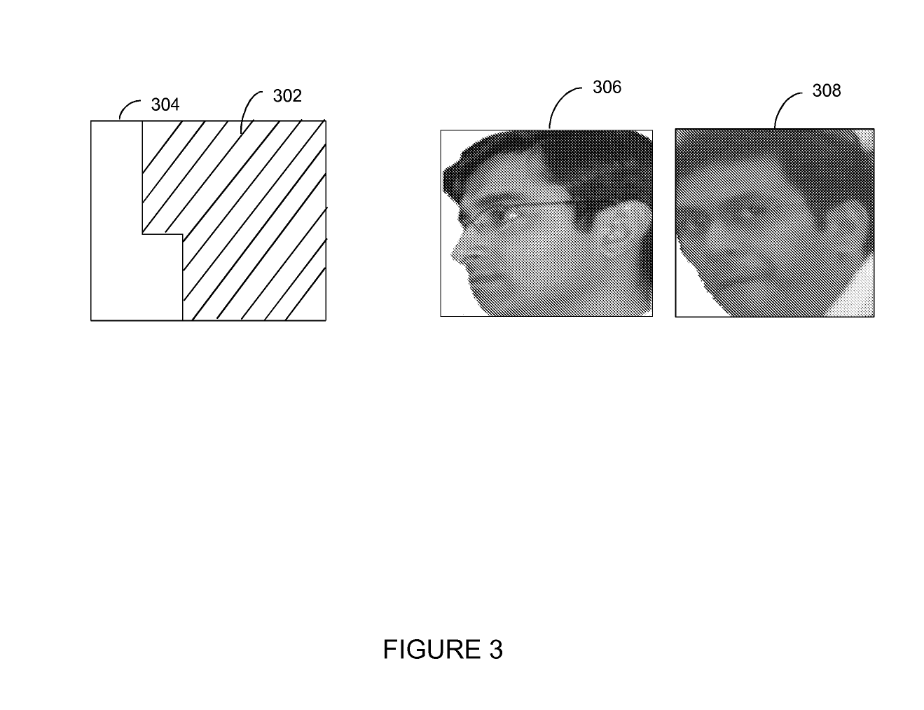

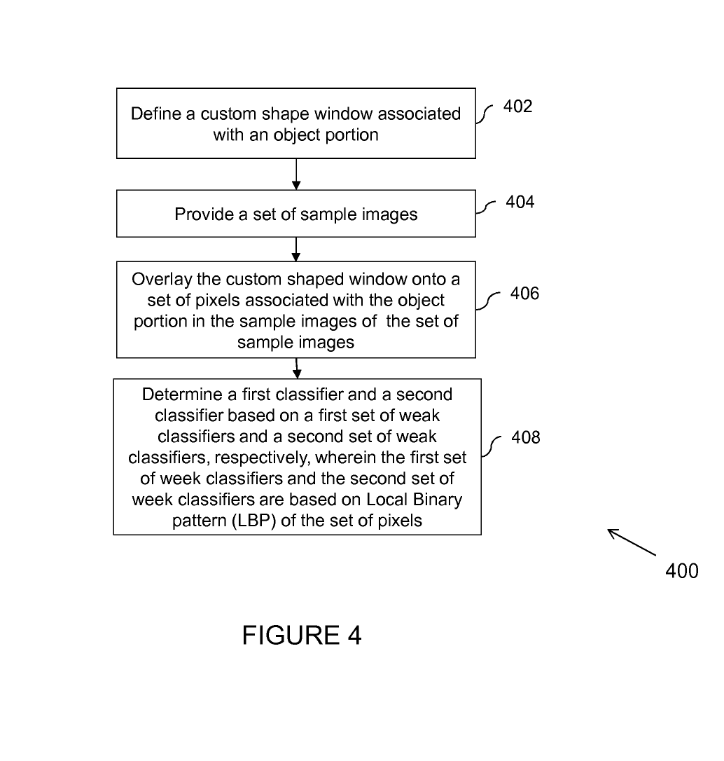

In an example embodiment, the processor 202 is configured to, with the content of the memory 204, and optionally with other components described herein, to cause the apparatus 200 to detect the object portion in the set of sample sub-windows based on a second classifier. In an example embodiment, the second set of weak classifiers may be derived based on the LBP values of a set pixels of sample images being derived during a training process of the second classifier. The example sample images for the training process of the first classifier and the second classifier is explained in conjunction with FIG. 3. Moreover, the training process of the first classifier and the second classifier is explained in conjunction with FIG. 4. In an example embodiment, a processing means may be configured to detect the object portion in the set of sample sub-windows based on the second classifier. An example of the processing means may include the processor 202, which may be an example of the controller 108.

In an example embodiment, the second classifier includes a second plurality of layers of classification functions. For example, the second classifier may include N₁, N₂, . . . Nₙ₂ (layers of classification functions. In an example embodiment, the number of layers associated with the first plurality of layers (for example n1) and the number of layers associated with the second plurality of layers (for example n2) are different. In another example embodiment, n1 and n2 are equal. Layers of the second plurality of layers of the classification function is representative of a decision function consisting of weak classifiers, and accordingly capable of deciding whether to reject a sample as a non-object (for example, non-face) or pass the sample to a subsequent layer for evaluation, In an example embodiment, the threshold associated with the second classifier may be designed in a manner to have a stricter false rejection relative to the first classifier, thereby maintaining an overall good accuracy of object detection.

In an example embodiment, the processor 202 is configured to, with the content of the memory 204, and optionally with other components described herein, to cause the apparatus 200 to determine the presence of the object portion in the at least one sub-window based on a comparison of a number of sample sub-windows detected by the second classifier of the set of sample sub-windows having the object portion with a predetermined threshold number. In an example embodiment, when the number of the sample sub-windows having the object portion is determined to be greater than the predetermined threshold, the at least one sub-window is verified to include the object portion. For example, a sub-window is detected to include an object portion by the first classifier, and a set of 25 sample sub-windows may be generated by using row shifting and column shifting of the sub-window. When the predetermined threshold is 5, then out of 25 sample sub-windows, even if at least 5 sub-windows are detected to contain the object portion by the second classifier, the input sub-window may be verified to include the object portion, In an example embodiment, a processing means may be configured to determine presence of the object portion in the sub-window based on the comparison of a number of the set of sample sub-windows detected to have the object portion with a predetermined threshold number. An example of the processing means may include the processor 202, which may be an example of the controller 108.

In an example embodiment, when the object portion is a face, the detected face portion may be merged with neighborhood faces that may be overlapping with the detected face portion, and a final face may be outputted.

In an example embodiment, the processor 202 is configured to, with the content of the memory 204, and optionally with other components described herein, to cause the apparatus 200 to train the first classifier and the second classifier prior to detecting the object portion in the at least one sub-window. In an example embodiment, the first classifier and the second classifier may be trained by first defining a custom shape window. For any input sample image used in training, the pixels bounded by the custom shape window may be considered as valid data for training the first classifier and the second classifier.

In an example embodiment, the first classifier and the second classifier may be computed by performing a training on the set of sample images. In an example embodiment, the training may be performed by overlaying the custom shape window onto a set of pixels associated with the object portion in the sample images. The first set of weak classifiers and the second set of weak classifiers may be determined by evaluating the LBP values of the set of pixels of the sample image. In an embodiment, a sample image of size N×N may be used for training. The LBP values are calculated for N×N window for sample image used in training, and a histogram of the LBP values are built for coordinates (x,y) in the sub-window N×N. These co-ordinates which internally embed the LBP histogram values are used as weak classifiers in training. In an embodiment, the first classifier uses a single co-ordinate as a weak classifier, and the weak classifiers of the first set of weak classifier associated with the first classifier may assume a co-ordinate value corresponding to one of the possible (N−2)*(N−2) co-ordinates. In an embodiment, the second classifier may utilize two co-ordinates at a time, and the second classifier may assume one of (N−2)*(N−3) possible values of 2-tuple weak classifiers.

FIG. 3 illustrates an exemplary custom shape window 302 for object detection in the media content in accordance with an example embodiment. In the example embodiment, for sample images, a specified shape of the window may be considered for the purpose of training. For example, as illustrated in FIG. 3, a 20×20 size sub-window, for example a sub-window 304 may be selected and a set of pixels bounded by the custom shape window may be considered for training of the first classifier and the second classifier. In an example embodiment, the shaded portion of the sub-window 304 (illustrated in FIG. 3) may be considered as the custom shape for the purpose of training the first classifier and the second classifier.

In an example embodiment, a custom shape associated with an object portion may be determined based on an information of object orientation. For example, a custom shape associated with face detection may be determined based on information regarding the orientation of face portion in the image. For example, for a full profile face sample such as sample face 306 having Yaw greater than 70 degree, there is a possibility of the background getting in to the input sub-window (as illustrated in FIG. 3). However, for the face having Yaw less than 50 degrees such as a sample face 308, the sub-window may mostly be filled with the face region. Utilizing this information of the sample faces, a custom shape may be defined that may be configured to accommodate both the face types (the sample face 306 and the sample face 308). The custom shape may be utilized for selecting a valid data portion for training of the first classifier and the second classifier. A method for training the first classifier and the second classifier is explained in conjunction with FIG. 4.

FIG. 4 is a flowchart depicting an example method 400 for training classifiers for object detection in the media content in accordance with an example embodiment. The method 400 depicted in the flow chart may be executed by, for example, the apparatus 200 of FIG. 2. Examples of the apparatus 200 include, but are not limited to, digital cameras, camcorders, mobile phones, personal digital assistants (PDAs), laptops, and any equivalent devices.

The method 400 describes steps for training the first classifier and the second classifier associated with detection of object portion in the media content. Examples of the media content may include, but are not limited to digital images, video content, and the like. In an example embodiment, a face is taken as an example of the object, however it may be understood that object may include any other object without limiting to the face.

In an example embodiment, the first classifier and the second classifier may be trained for detection of faces occurring in a range of the orientations or poses varying from 0 to 90 Yaw. The range of face orientation to be classified may be increased without compromising on the false positives and computational complexity, so the face detection classifiers may be configured to detect all kinds of faces belonging to various facial orientations including Yaw 0-30, Yaw (30-60, Yaw 60-90, and the like.

At 402, a custom shape associated with the object portion may be defined. The custom shape associated with the object portion may refer to a shape or a model that may be trained to detect objects occurring in a range of orientations or poses. In an example embodiment, wherein the object is a face, the custom shape may be defined as explained and represented in FIG. 3.

At 404, a set of sample images may be provided. In an example embodiment, the set of sample images may include images of different orientations ranging from 0 to 90 Yaw. In an example embodiment, for input sample image (of size, for example 20×20), a set of pixels present in the custom shape window may be considered for training (as illustrated by shaded portion in FIG. 3).

At block 406, the custom shape window may be overlaid onto a set of pixels associated with the object portion in the sample images of the set of sample images. At block 408, a first set of weak classifiers associated with the first classifier and a second set of weak classifiers associated with the second classifier may be determined by evaluating the LBP values of the set of pixels. In an example embodiment, the first set of weak classifiers and the second set of week classifiers may be determined in an offline training process.

In an example embodiment, during the offline training process, the LBP values are calculated for the N×N sub-window of the sample images, and a histogram of the LBP values is built for coordinates (x,y) in the N×N sub-window. These co-ordinates internally embed the LBP histogram values, and are used as weak classifiers. In an embodiment, the first classifier uses a single co-ordinate as a weak classifier, and the weak classifier associated with the first classifier may assume a co-ordinate value corresponding to one of the possible (N−2) co-ordinates. In an embodiment, the second classifier may utilize two co-ordinates at a time, and the second classifier may assume one of (N−2)*(N−3) possible values of 2-tuple weak classifiers.

In the present implementation, the first classifier and the second classifier may be trained utilizing same database of sample images. However, the training of the first classifier and the second classifier differs in the nature of weak classifiers utilized for classification, thereby reducing the complexity in detection of objects. Moreover, the first classifier and the second classifier are trained for a range of object orientations, thereby enhancing the ability to remove false detection. Also, the threshold of first classifier is relaxed, thereby allowing more number of samples to be detected along with false alarms, however, the second stage/classifier is designed to have a good false rejection, thereby maintaining an overall good detection accuracy.

In an example embodiment, a processing means may be configured to perform some or all of: defining the custom shaped window associated with the object portion; providing a set of sample images; overlaying the custom shape window onto the set of pixels associated with the object portion in the set of sample images; and determining the first set of weak classifiers and the second set of weak classifiers by training on the set of sample images based on LBP values of the set of pixels. An example of the processing means may include the processor 202, which may be an example of the controller 108.

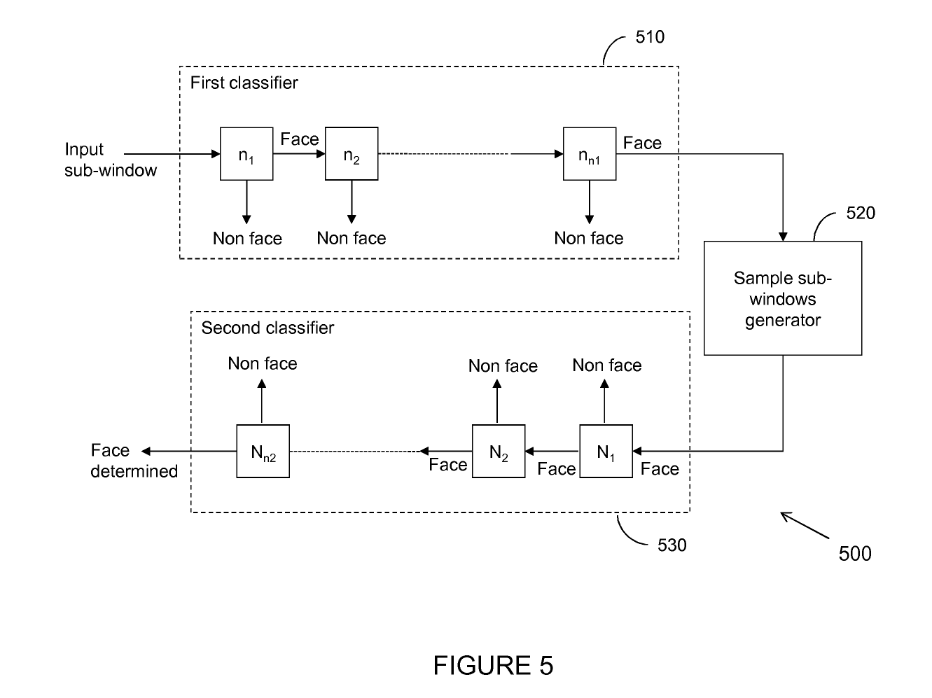

FIG. 5 illustrates a block diagram 500 for object detection in accordance with an example embodiment. The block diagram includes a first classifier 510, a sample sub-window generator 520 and a second classifier 530. As illustrated in FIG. 5, the first classifier includes a first plurality of layers of classification functions. The first plurality of layers of the classification layers include layers such as layer n₁, layer n₂, . . . layer nₙ₁, and the like. Examples of the first set of weak classifiers associated with a face portion include, but are not limited to, a pair of eyes and a mouth portion. Layers of the first plurality of layers of the classification function is representative of a decision function consisting of weak classifiers, and accordingly capable of deciding whether reject a sample as a non-object (for example, non-face) or pass the sample to a subsequent layer for evaluation. In addition, layers has a predefined threshold obtained in training which affects the detection of the presence of the object in the sub-window.

In an example illustrated in FIG. 5, the first classifier 510 is applied to a plurality of input sub-windows associated with an image. The plurality of sub-windows may be passed through the first plurality of layers of classifications function, such as the layer n₁, the layer n₂ . . . the layer nₙ₁, and so on. The first plurality of layers may classify the plurality of sub-windows as one of a ‘face’ or a ‘non-face’ based on the first set of weak classifiers and used in decisions functions of corresponding layers. In an example embodiment, at least one sub-window of the plurality of sub-windows may be classified as face.

In an example embodiment, the at least one sub-windows classified as face may be utilized for generating a set of sample sub-windows by the sample sub-window generator 520. In an example embodiment, the set of sample sub-windows may be generated by performing at least one of row-shifting and column shifting of the at least one sub-window. The set of sample sub-windows may be passed through the second classifier 530 for classifying the set of sample sub-windows into ‘face’ and ‘non-face’. In an example embodiment, the set of sample sub-windows may be passed through the second plurality of layers of classification functions, such as the layer N₁, the layer N₂, . . . the layer Nₙ₂, and so on to detect a presence of the face in the set of the sample sub-windows. The sub-window determined to have the ‘face’ may be the output, as illustrated in FIG. 5.

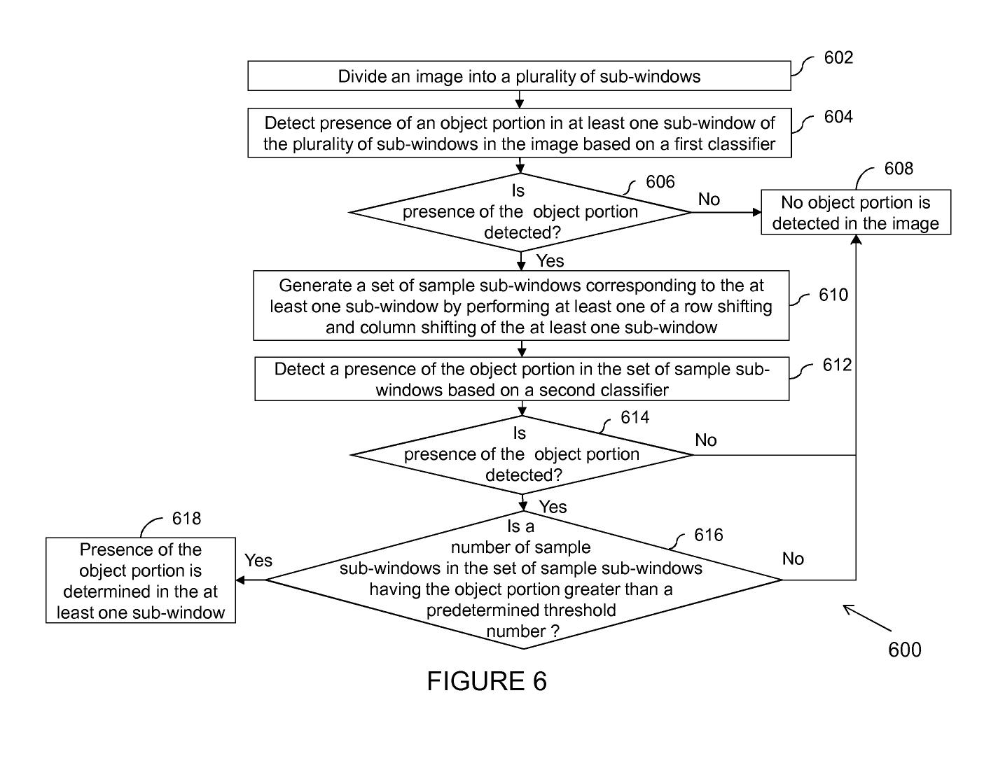

FIG. 6 is a flowchart depicting an example method 600 for object detection in media content in accordance with another example embodiment. The method 600 depicted in flow chart may be executed by, for example, the apparatus 200 of FIG. 2. It may be understood that for describing the method 600, references herein may be made to FIGS. 1, 2 and 5. The method may be explained with reference to face detection in an image, however, the method may be equally applicable for the determination any other object in the media content.

Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 600 are described with help of apparatus 200. However, the operations of the method 600 can be described and/or practiced by using any other apparatus.

A media content may include an object. In an example embodiment, the media content may be an image of an object. In an example embodiment, the object portion may be a face portion. In an example embodiment, the face portion may be in one of the orientations ranging from 0 to 90 Yaw. At block 602, the image may be divided into a plurality of sub-windows.

At block 604, a presence of an object portion in at least one sub-window of the plurality of sub-windows may be detected in the image based on a first classifier. In an example embodiment, the plurality of sub-windows may be examined for detecting the presence of the object portion by the first classifier. In an example embodiment, the first classifier may be associated with a first plurality of weak classifiers. As explained with reference to FIG. 4, the first classifier may be trained with slightly relaxed detection criterion such that detection is maximum and false acceptance is compromised. The tendency of the first classifier is to increase the face detection with increased false detections.

At block 606, it may be determined whether presence of the object portion is detected in the at least one sub-window of the plurality of sub-windows. If at block 606, no object portion is determined to be present in the at least one sub-window, an absence of the object portion is determined in the image at block 608. However, if presence of the object portion is determined in at least one sub-window, a set of sample sub-windows associated with the at least one sub-window may be generated at block 610. In an example embodiment, the set of sample sub-windows may be generated by performing at least one of a row shifting and column shifting of the at least one sub-window. In an example embodiment, the at least one of a row shifting and column shifting of the sub-window may be performed based on the following expression:

A_{x,y}(m,n)=A(m+x,n+y),

wherein A is the sub-window, and
A_{x,y} is the generated sample sub-window.

For example, as x varies from a value of −2 to +2, and y varies from a value of −2 to +2, 25 sample sub-windows may be generated. In an embodiment, the generated set of sample sub-windows may border a set of pixels.

At block 612, a presence of the object portion is detected in the set of sample sub-windows based on a second classifier. In an example embodiment, the second classifier is associated with a second set of weak classifiers. In an example embodiment, the second set of weak classifiers may be composed of two coordinates in the custom shape window, wherein the two coordinates specifies two LBP values at one time. In an example embodiment, the second classifier comprises a plurality of layers of classification functions, such as N₁, N₂ . . . Nₙ₂. In an example embodiment, the second classifier is designed to provide a good false rejection relative to the first classifier.

At block 614, it is determined whether the object portion is detected in the set of sample sub-windows. If at block 614, it is determined that the object portion is not present in any of the set of sample sub-windows, an absence of the object portion is determined in the image at block 608. If however, the object portion is detected in the set of sample sub-windows, it is determined at block 616 whether a number of the set of sample sub-windows detected by the second classifier to have the object portion is greater than a predetermined threshold number.

If at block 616, it is determined that the number of the set of sample sub-windows having the object portion is not greater than the predetermined threshold number, it may be determined at block 608 that the image does not contain the object portion. In an example embodiment, it may imply that the at least one sub-window was falsely determined to include the object portion by the first classifier. However, if at block 616, the number of the set of sample sub-windows detected to have the object portion is determined to be greater than the predetermined threshold number, then the presence of the object portion is determined in the at least one sub-window at block 618. In an example embodiment, when the object portion is a face, the detected face may be merged with neighborhood faces that may be overlapping with the detected faces, and a final face may be the output.

It will be understood that although the method 600 of FIG. 6 shows a particular order, the order need not be limited to the order shown, and more or fewer blocks may be executed, without providing substantial change to the scope of the present disclosure.

Without in any way limiting the scope, interpretation, or application of the claims appearing below, a technical effect of one or more of the example embodiments disclosed herein is to detect an object in the media content. The disclosed embodiments facilitates detection of an object belonging to a range of orientations varying from 0 to 90 degree Yaw using a minimum number of classifiers (for example two classifiers), thereby reducing computation complexity. The threshold of a first classifier is relatively relaxed as compared to a second classifier, thereby allowing more number of object samples to be detected along with the false alarms. However the second classifier provides stricter false rejection, thereby maintaining overall improved detection accuracy of object detection. Also, the first classifier and the second classifier are based on different set of weak classifiers, and accordingly for a false positive to be detected incorrectly, both the classifiers have to be satisfied, which are different in their nature of classification.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications which may be made without departing from the scope of the present disclosure as defined in the appended claims.

1-35. (canceled)

36. A method comprising:
detecting presence of an object portion in at least one sub-window in an image based on a first classifier, the first classifier being associated with a first set of weak classifiers;
generating a set of sample sub-windows corresponding to the at least one sub-window detected by the first classifier by performing at least one of row shifting and column shifting of the at least one sub-window;
detecting a presence of the object portion in the set of sample sub-windows based on a second classifier, the second classifier being associated with a second set of weak classifiers; and
determining the presence of the object portion in the at least one sub-window based on the comparison of a number of sample sub-windows detected by the second classifier in the set of sample sub-windows comprising the object portion with a predetermined threshold number.

37. The method as claimed in claim 36, further comprising training the first classifier and the second classifier prior to detecting the object portion in the at least one sub-window.

38. The method as claimed in claim 37, further comprising defining a custom shape window associated with the object portion for training the first classifier and the second classifier.

39. The method as claimed in claim 38, wherein training the first classifier and the second classifier further comprises performing training on a set of sample images by performing for sample images of the set of sample images:
overlaying the custom shaped window onto a set of pixels associated with the object portion in the sample images; and
determining the first set of weak classifiers and the second set of weak classifiers by evaluating a local binary pattern (LBP) values of the set of pixels.

40. The method as claimed in claim 39, wherein the first set of weak classifiers comprises a LBP value associated with the custom shape window, and the second set of weak classifiers comprises at least two LBP values associated with the custom shape window.

41. The method as claimed in claim 36, wherein generating the set of sample sub-windows is based on the expression defined as:
A_{x,y}(m,n)=A(m+x,n+y),
wherein A is the sub-window, A_{x,y} is the generated sample sub-window generated by performing the at least one of the row (x) shifting and the column (y) shifting.

42. The method as claimed in claim 36, wherein the first classifier and the second classifier are computed for a range of orientation of the object portion, the range of orientations of the object portion varying from 0 to 90 Yaw.

43. The method as claimed in claim 36, wherein the number of the set of sample sub-windows detected by the second classifier being greater than the predetermined threshold number verifies the presence of the object portion in the at least one sub-window.

44. An apparatus comprising:
at least one processor; and
at least one memory comprising computer program code, the at least one memory and the computer program code configured to, with the at least one processor, cause the apparatus at least to:
detect presence of an object portion in at least one sub-window in an image based on a first classifier, the first classifier being associated with a first set of weak classifiers;
generate a set of sample sub-windows corresponding to the at least one sub-window detected by the first classifier by performing at least one of row shifting and column shifting of the at least one sub-window;
detect a presence of the object portion in the set of sample sub-windows based on a second classifier, the second classifier being associated with a second set of weak classifiers; and
determine the presence of the object portion in the at least one sub-window based on the comparison of a number of sample sub-windows detected by the second classifier in the set of sample sub-windows comprising the object portion with a predetermined threshold number.

45. The apparatus as claimed in claim 44, wherein the apparatus is further caused, at least in part, to: train the first classifier and the second classifier prior to detecting the object portion in the at least one sub-window.

46. The apparatus as claimed in claim 45, wherein the apparatus is further caused, at least in part, to: define a custom shape window associated with the object portion for training the first classifier and the second classifier.

47. The apparatus as claimed in claim 46, wherein the apparatus is further caused, at least in part, to:
train the first classifier and the second classifier by performing training for sample images on a set of sample images;
overlay the custom shaped window onto a set of pixels associated with the object portion in the sample images; and
determine the first set of weak classifiers and the second set of weak classifiers by evaluating the LBP values of the set of pixels.

48. The apparatus as claimed in claim 47, wherein the first set of weak classifiers comprises a LBP value associated with the custom shape window, and the second set of weak classifiers comprises at least two LBP values associated with the custom shape window.

49. The apparatus as claimed in claim 44, wherein the apparatus is further caused, at least in part, to: generate the set of sample sub-windows based on the expression defined as:
A_{x,y}(m,n)=A(m+x,n+y),
wherein A is the sub-window, A_{x,y} is the generated sample sub-window generated by performing the at least one of the row (x) shifting and the column (y) shifting.

50. The apparatus as claimed in claim 44, wherein the apparatus is further caused, at least in part, to: train the first classifier and the second classifier for a range of orientation of the object portion, the range of orientations of the object portion varying from 0 to 90 Yaw.

51. The apparatus as claimed in claim 44, wherein the apparatus is further caused, at least in part, to: verify the presence of the object portion in the at least one sub-window when the number of the set of sample sub-windows detected by the second classifier is determined to be greater than the predetermined threshold number.

52. A computer program comprising a set of instructions, which, when executed by one or more processors, cause an apparatus at least to perform:
detecting presence of an object portion in at least one sub-window in an image based on a first classifier, the first classifier being associated with a first set of weak classifiers;
generating a set of sample sub-windows corresponding to the at least one sub-window detected by the first classifier by performing at least one of row shifting and column shifting of the at least one sub-window;
detecting a presence of the object portion in the set of sample sub-windows based on a second classifier, the second classifier being associated with a second set of weak classifiers; and
determining the presence of the object portion in the at least one sub-window based on the comparison of a number of sample sub-windows detected by the second classifier in the set of sample sub-windows comprising the object portion with a predetermined threshold number.

53. The computer program as claimed in claim 52, wherein the apparatus is further caused, at least in part, to perform: training the first classifier and the second classifier prior to detecting the object portion in the at least one sub-window.

54. The computer program as claimed in claim 53, wherein the apparatus is further caused, at least in part, to perform: defining a custom shaped window associated with the object portion for training the first classifier and the second classifier.

55. The computer program as claimed in claim 54, wherein the apparatus is further caused, at least in part, to perform: training the first classifier and the second classifier by performing training on a set of sample images, the training comprises performing for sample images of the set of sample images:
overlaying the custom shaped window onto a set of pixels associated with the object portion in the sample images; and
determining the first set of weak classifiers and the second set of weak classifiers by evaluating the LBP values of the set of pixels based.
